(19) United States
(12) Patent Application Publication
(10) Pub. No.: US 2015/0157008 A1
(43) Pub. Date: Jun. 11, 2015

(54) Tree Hugger

(71) Applicant: Robert Lavern Sunday, Jackson, MI (US)

(72) Inventor: Robert Lavern Sunday, Jackson, MI (US)

(21) Appl. No.: 14/069,435

(22) Filed: Dec. 9, 2013

(51) Int. Cl. A01M 31/02; A47C 1/00

(52) U.S. Cl. CPC A01M 31/02; A47C 1/00

(57) ABSTRACT

The Tree Hugger design of 2 legs and a tree is unique to the sport of hunting accessories. This seat provides the most solidly secured versatile way to hunt. The market is flooded with 3 legged height adjustable less stable stools/seats. Most have no back support or canvas backs, which provide much less stability and support. The Tree Hugger's closed carrying position, with a built in handle is light and flat without having to remove the legs. Nature's trees not only support you, they provide friendly cover and protection.

### CROSS-REFERENCE TO RELATED APPLICATIONS

A review of appropriate publications found no comparisons.

### STATEMENT REGARDING FEDERALLY SPONSORED RESEARCH OR DEVELOPMENT

Not applicable.

### BACKGROUND OF THE INVENTION

I am an avid deer hunter and have experienced many different types of tree stands and hunting stool/seats. Focusing on the wide array of situational experiences, I looked for the ideal way to effectively & comfortably position myself for a successful day. Two years ago, I developed a seat with only two legs, “The Tree Hugger”. This particular design allows for a level and comfortable sitting position when an uneven soil surface and/or protruding tree roots exist, like around most trees. Major retailers such as Cabela's and the Sportsman's Guide do not market a product with this design concept. Additionally, major manufactures such as Quake Industries, Ameristep, and Big Game Tree Stands do not manufacture a product with this design concept.

### BRIEF SUMMARY OF THE INVENTION

The Tree Hugger is a versatile lightweight seat to carry whether you are in the woods, on a golf course or in your backyard. Its design allows you to overcome terrain problems that no 3 legged seat can comfortable resolve.

### BRIEF DESCRIPTION OF THE SEVERAL VIEWS OF THE DRAWINGS

FIG. 1. The Tree Hugger in open position-isometric view

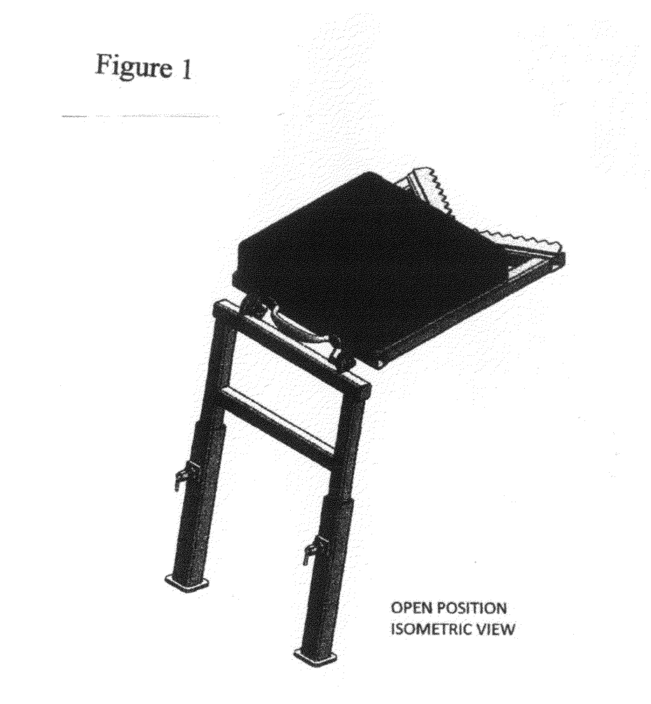

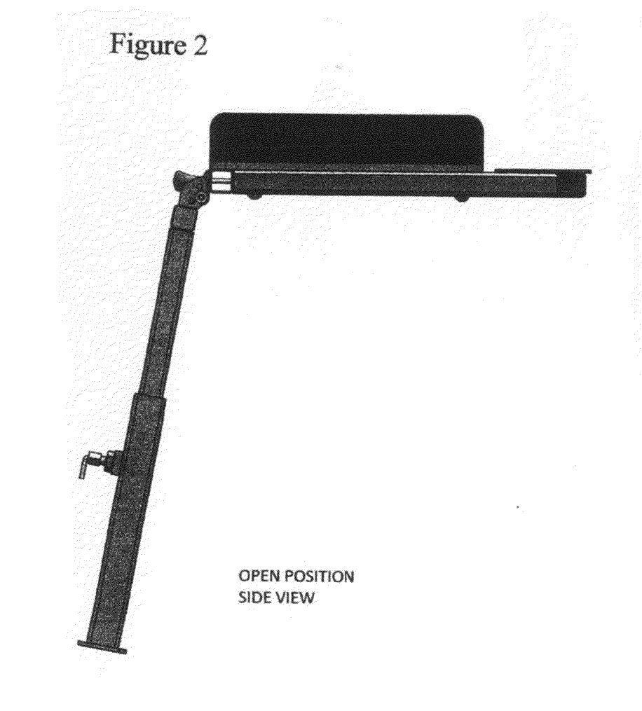

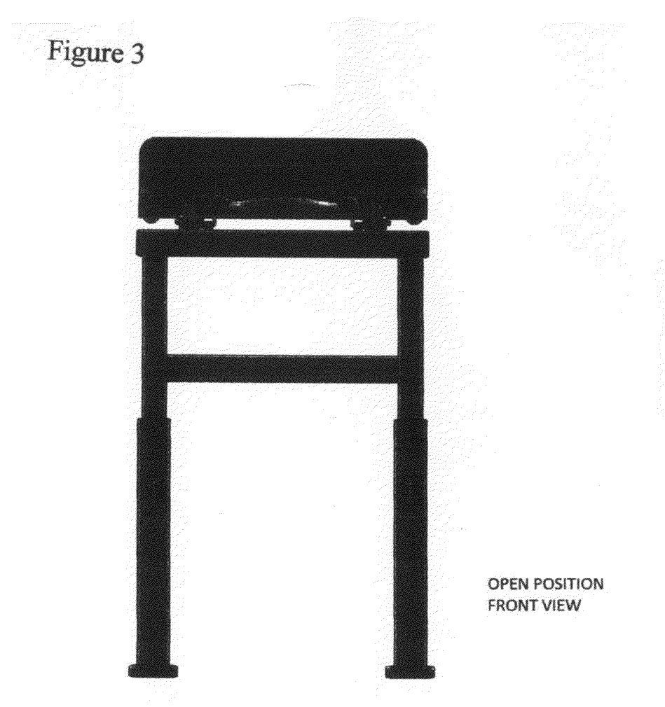

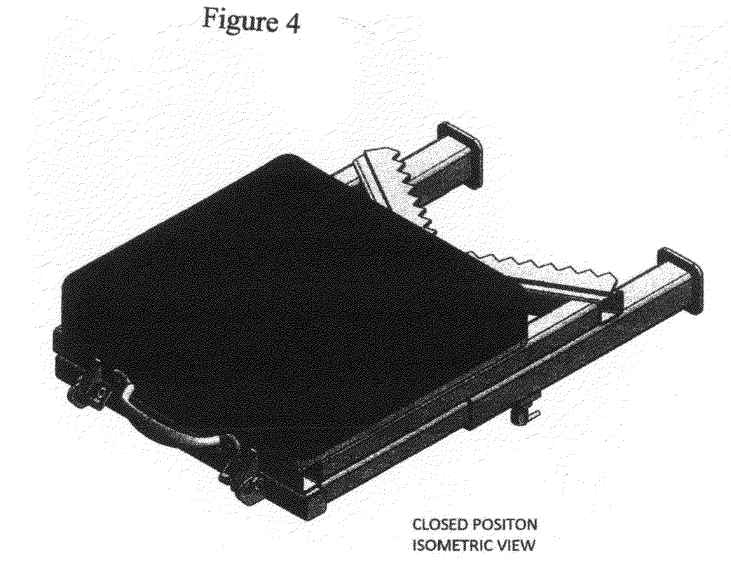

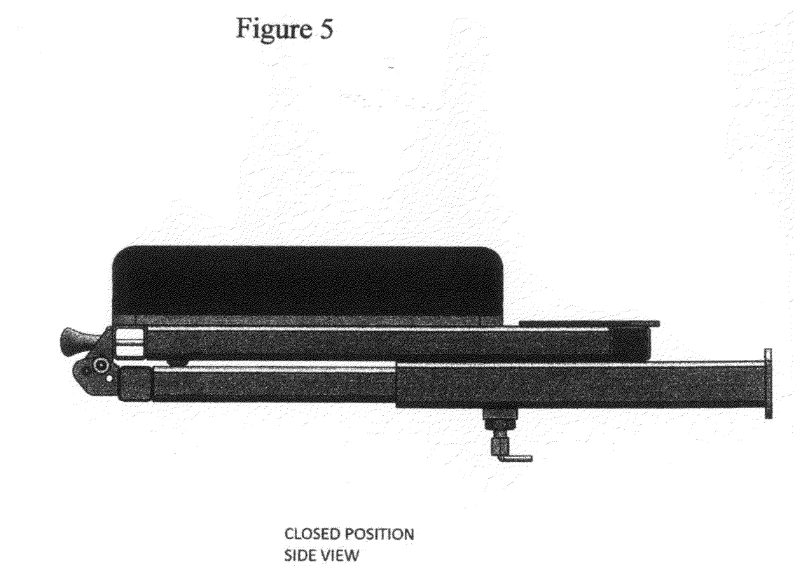

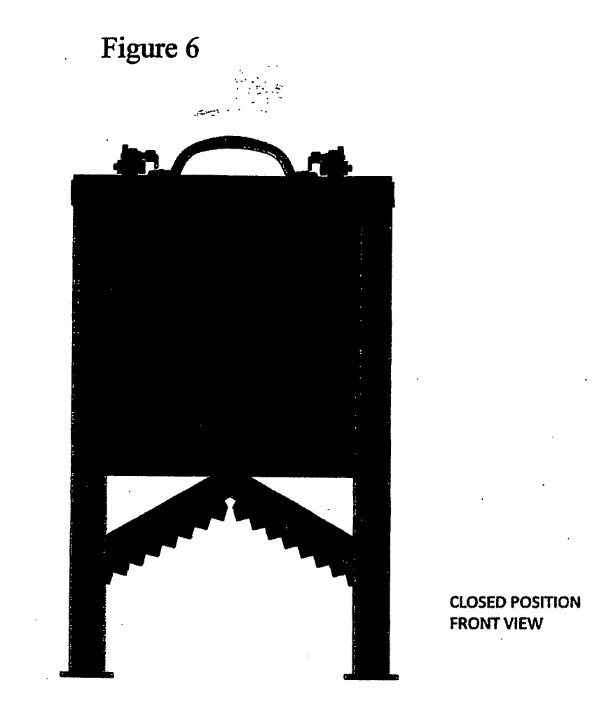

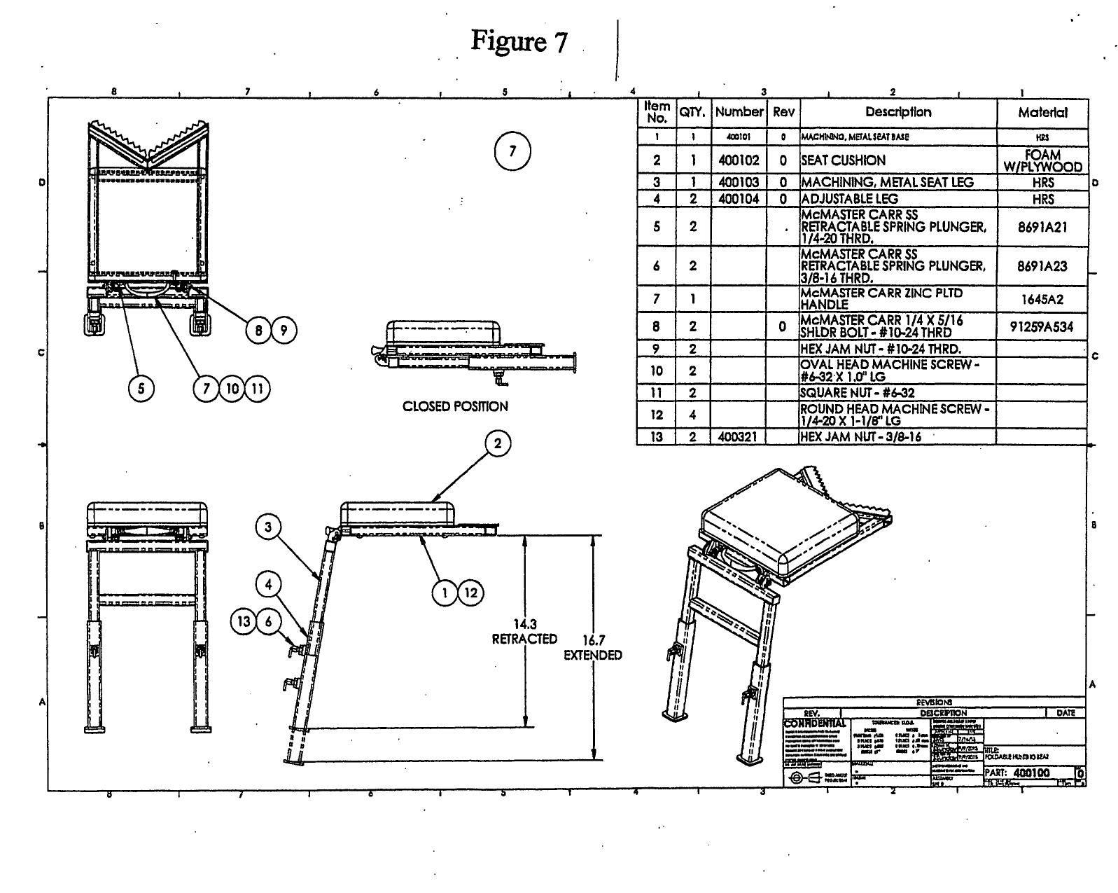

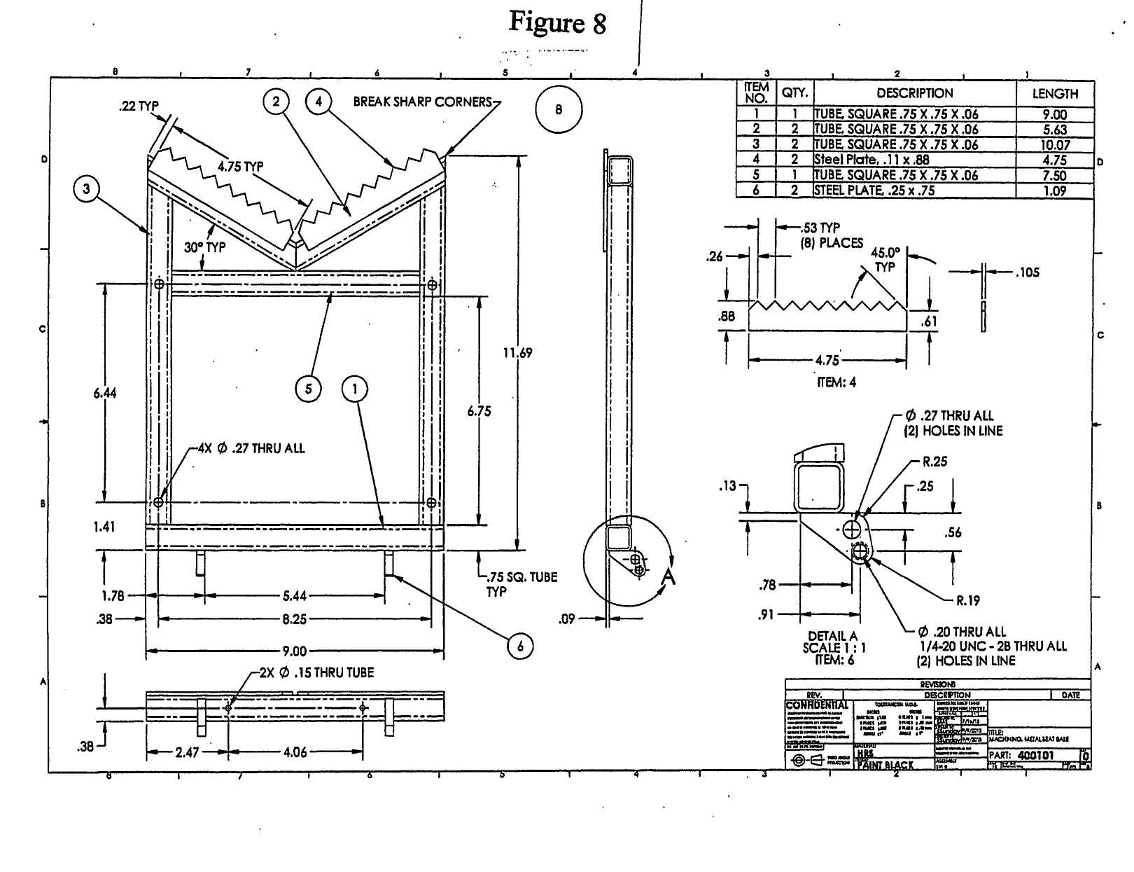

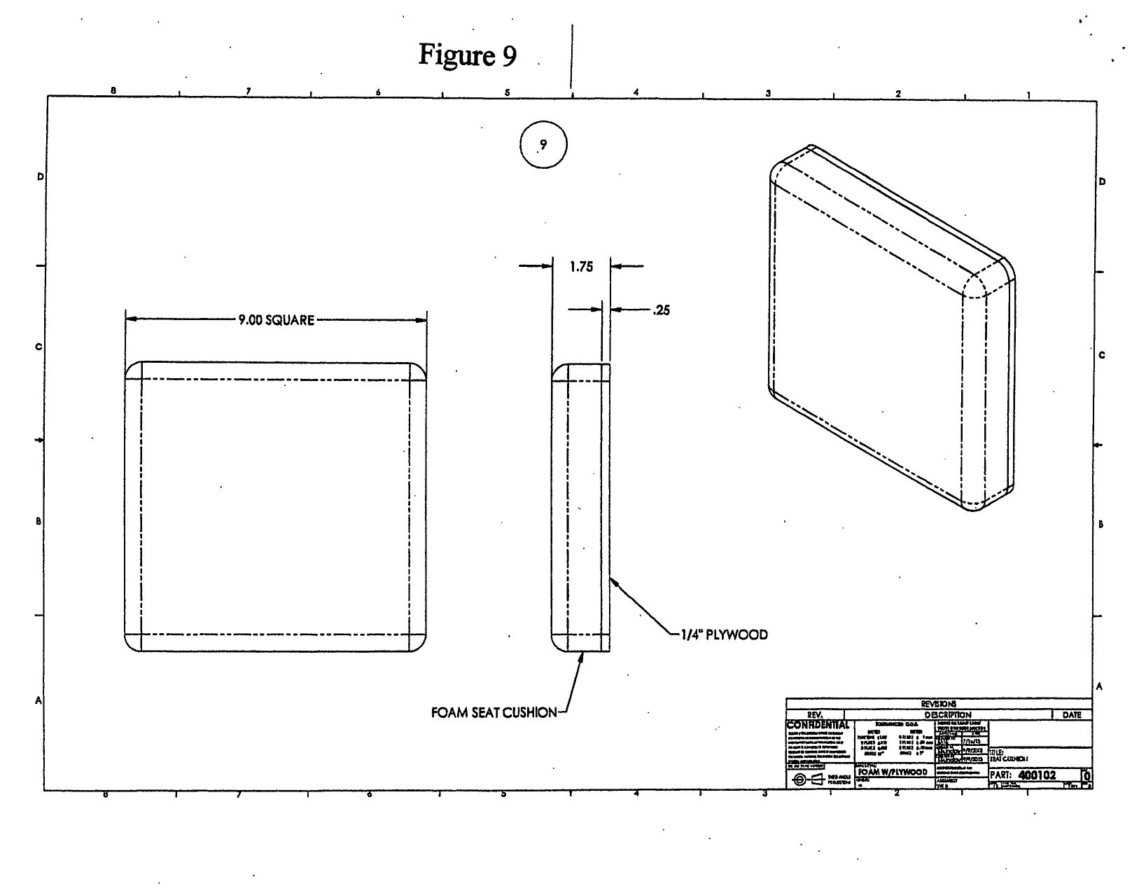

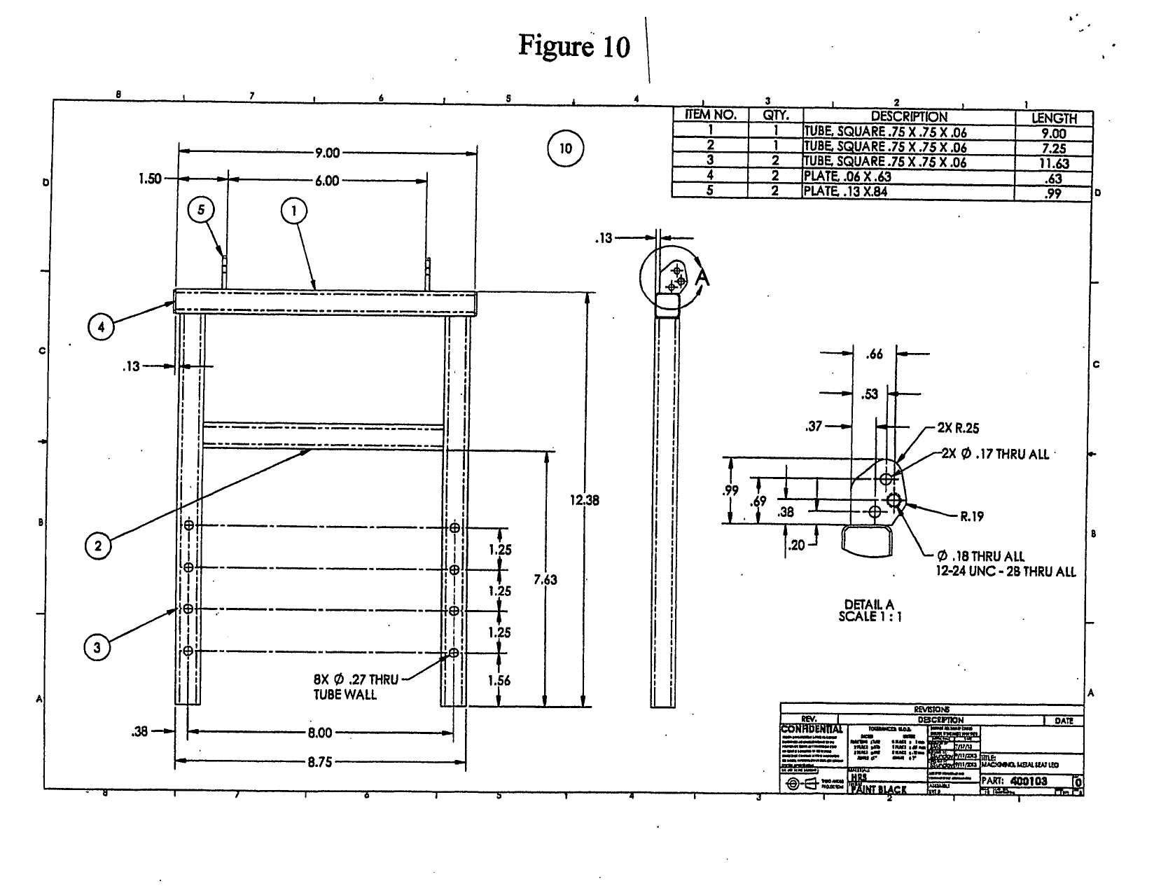

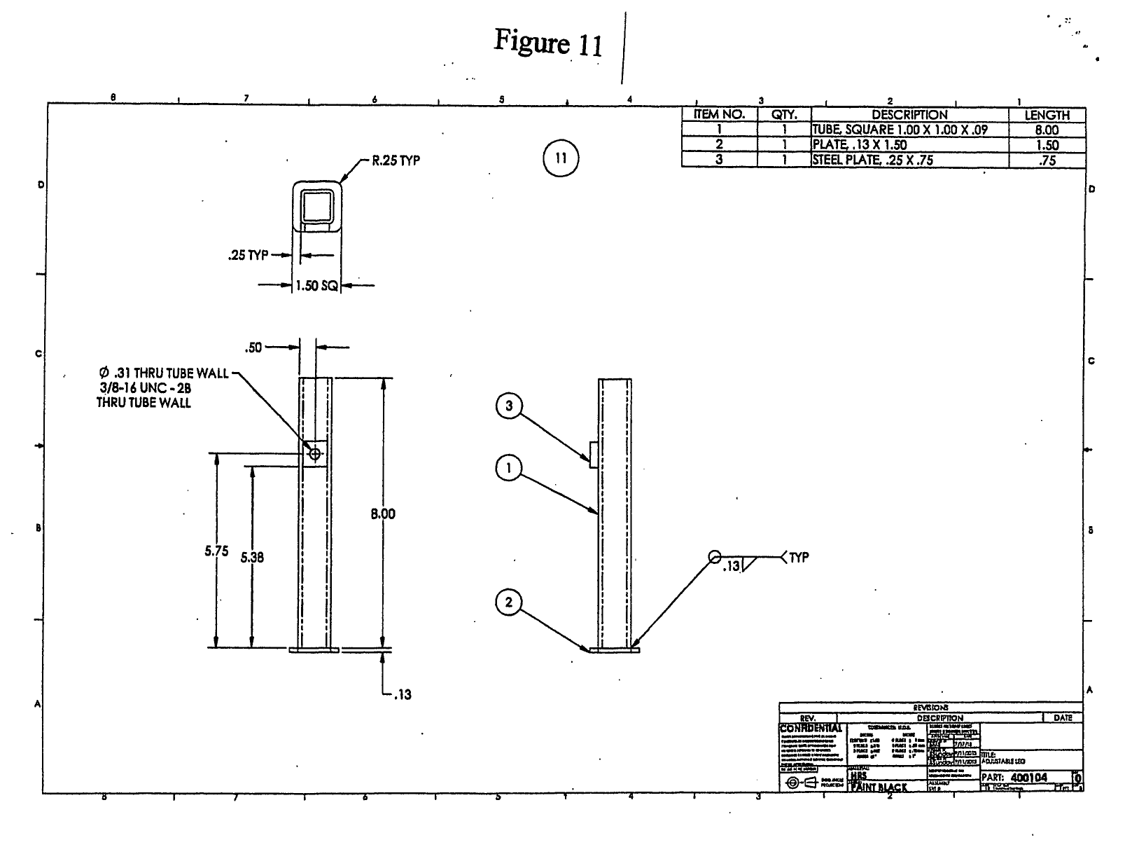

2. Open position-side view

3. Open position-front view

4. Closed position-isometric view

5. Closed position-side view

6. Closed position-front view

7. Parts list, views-top, closed side, opened side, opened front, isometric

8. Dimensional view top

9. Cushion views-top, side, isometric

10. Height adjustment positions-front view

11. Tube stock-leg

### DETAILED DESCRIPTION OF THE INVENTION

The design literally hugs the tree with a machined steel plate which solidly secures the seat to a wide size range of trees. The 2 legs are square aluminum tube stock which can be height adjusted independently. The adjustment is accomplished by hand with a retractable spring plunger. The whole set up process is as easy as opening a typical folding chair.

The Tree Hugger's compact and lightweight design with attached handle can be easily carried into even the most remote hunting locations. The seat is 9 inches square and features a 1¾ padded waterproof cushion for comfort.

In addition to hunting applications, it could be utilized by bird watchers, golf spectators, campers etc. Also, a post, building or any other creative items could replace a tree.

1. A comfortable and sturdy seat that overcomes adverse terrain variations in close proximity to a wide range of tree sizes.

2. Two legged design provides for a compact and lightweight carrying package.

3. Four height adjustments in 1¾ inch increments.

4. A stabilizing third point(leg) for support can be provided by a tree, post, or a building.

5. Rugged weather-resistant construction.
